(19) United States
(12) Patent Application Publication
(10) Pub. No.: US 2012/0287115 A1
(43) Pub. Date: Nov. 15, 2012

(54) METHOD FOR GENERATING IMAGE FRAMES

(76) Inventors: JunJie Ding, Hangzhou City (CN); GuoGang Wang, Hangzhou City (CN); Jin Wang, Hangzhou City (CN)

(21) Appl. No.: 13/104,030

(22) Filed: May 10, 2011

(51) Int. Cl. G06T 15/00

(52) U.S. Cl. 345/419

(57) ABSTRACT

A method for generating image frames includes setting a 3D display mode of the image frames, configuring at least one parameter of the image frames, and displaying the image frames according to the 3D display mode and the at least one parameter of the image frames. When an input command is received while displaying the image frames, the input command is determined to correspond to parameters of the image frames or not. If the input command does not correspond to parameters of image frames, the parameters of image frames are reconfigured according to the input command.

### BACKGROUND OF THE INVENTION

1. Field of the Invention

The present invention is related to a method for generating image frames, and more particularly, to a method for generating three-dimensional (3D) image frames without requiring 3D hardware.

2. Description of the Prior Art

Nowadays 3D technology is blending into more and more aspects of consumers' everyday life. 3D technology covers applications in architecture, medical, entertainment and consumer electronics etc. For instance, 3D films and games, as well as products such as 3D television and 3D digital photo frame, all deploy 3D technology heavily.

However, one of the drawbacks of 3D technology is the requirement of 3D hardware such as 3D chips, which are often costly and increase factors such as circuit space and heat dissipated etc. In addition, certain peripherals such as 3D glasses may be needed for the user to experience the 3D effect.

Implementing 3D hardware on relative compact (e.g. low profile) devices, e.g. digital still camera (DSC), mobile phones and digital photo frames etc., may be impractical due to factors such as size, design architecture and cost etc. Image displayed or user interface (UI) implemented for a compact device is mostly two-dimensional (2D) based, or 2D-based with switching effects (still 2D-based). Consequently, visual effects and related user experience are limited for compact devices.

### SUMMARY OF THE INVENTION

The present invention discloses a method for generating image frames. The method comprises setting a 3D display mode of the image frames; configuring at least one parameter of the image frames; displaying the image frames according to the 3D display mode and the at least one parameter of the image frames; when an input command is received while displaying the image frames, determining whether the input command corresponds to the at least one parameter of the image frames; and if the input command does not correspond to the at least one parameter, reconfiguring the at least one parameter according to the input command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart illustrating a method of the present invention for generating image frames.

FIG. 2 is a diagram illustrating an embodiment of utilizing method to generate a 3D user interface.

FIG. 3 is a diagram illustrating an embodiment of selecting a different major class of 3D user interface in FIG. 2.

FIG. 4 is a diagram illustrating an embodiment of selecting a different sub-class from the same major class of 3D user interface in FIG. 2.

FIG. 5 is a diagram illustrating an embodiment of utilizing method to generate a photo wall.

FIG. 6 is a diagram illustrating an embodiment of utilizing method to generate a photo cube.

FIG. 7 is a diagram illustrating an embodiment of utilizing method to generate a photo sphere.

FIG. 8 is a diagram illustrating an embodiment of utilizing method to generate a photo spiral.

### DETAILED DESCRIPTION

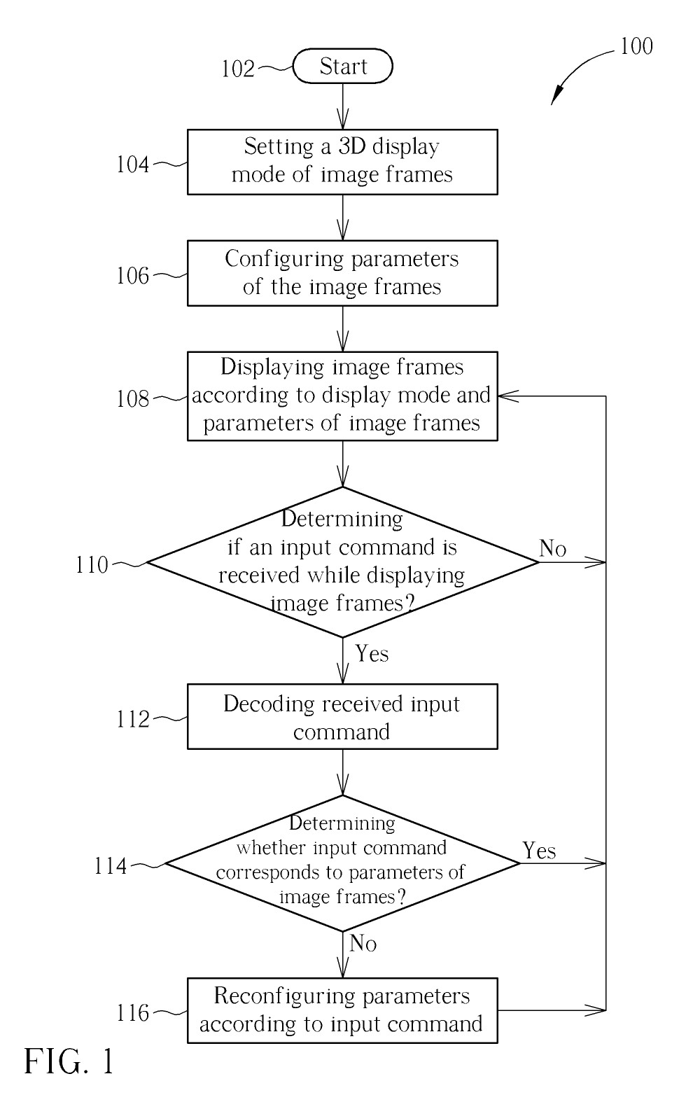

Please refer to FIG. 1. FIG. 1 is a flow chart illustrating a method 100 of the present invention for generating image frames. The image frames, for instance, may be icons of a user interface for triggering different functions of a compact device. The steps of method 100 are detailed below:

Step 102: start;

Step 104: setting a 3D display mode of the image frames;

Step 106: configuring at least one parameter of the image frames;

Step 108: displaying the image frames according to the 3D display mode and the at least one parameter of the image frames;

Step 110: determining if an input command is received while displaying the image frames; if so, proceed to step 112, otherwise proceed to step 108;

Step 112: decoding the received input command;

Step 114: determining whether the input command corresponds to any of the at least one parameter of the image frames; if so, proceed to step 108, otherwise proceed to step 116;

Step 116: reconfiguring the at least one parameter according to the input command.

Steps 102-106 describe initialization of method 100 of the present invention, for determining how the image frames are presented. Firstly a 3D display mode for displaying the generated image frames is set. For instance, image frames can be set in step 104 to display in modes such as photo wall, spiral and sphere etc. At least one parameter relative to the image frames is then configured in step 106. Parameters comprise coordinates, movement trace and frame rate of the image frames etc. Movement trace represents the trajectory and/or movement distance of effect relative to the image frames. For instance, if image frames are displayed in photo wall mode, the movement trace corresponds to a sliding trajectory of the image frames; if the image frames are displayed in spiral mode, the movement trace corresponds to a helix trajectory of the image frames; if the image frames are displayed in sphere, the movement trace corresponds to a revolving trajectory of the sphere.

After the image frames have been initialized, the image frames are displayed in step 108 according to display mode and parameters set insteps 104 and 106 respectively. For instance, to display image frames in step 108, a first frame data of the image frames is prepared according to the set mode and parameters. The first frame data is then forwarded one by one to an output module such as an internal/external frame buffer of the compact device.

It is noted that prior to displaying a frame data of image frames, an internal thread may be executed by the processing unit for requesting an identification of frame data of the image frame to be displayed, as well as notifying the identification of frame data of the image frame that is ready to be displayed. The internal thread may be a cached thread, for instance.

In step 110, method 100 determines if an input command is received while displaying the image frames. Input command may be generated externally, e.g. by a user input. Taking photo wall mode as an example, the input command may be the user sliding through the photo wall or selecting a specific photo for viewing. In other embodiments, input command may also be system generated, for instance, by a processing unit of the compact device.

When the processing unit does not have sufficient time/resources to process a frame data of image frames, the process unit generates an input command for displaying a substitute image frame, e.g. certain symbols such as a sandglass symbol is displayed to notify the user the system is in processing operation, until the frame data of image frames has finished processing and ready to be displayed. When a substitute frame is being displayed, the internal thread (e.g. cached thread) notifies an identification of the frame data of substitute image frame, and the substitute frame is forwarded to the frame buffer.

When an input command is received and recognized, the input command is decoded in step 112 so as to identify content of the input command, for determining whether the received input command is new. Decoded content of the received input command is then compared to parameters set in step 102-106. If the decoded content of the received input command does not correspond to the set parameters of the image frames, the received input command is considered to be new; the parameters of the image frames are reconfigured according to the new input command. For instance, an event handler may be invoked to reconfigure parameters of the image frames according to the input command. Step 108 is repeated to display image frames according to reconfigured parameters.

If the decoded content of input command does correspond to parameters of the image frames, e.g. the received input command is not new, then step 108 is repeated to display image frames without reconfiguring parameters of the image frames such that image frames are displayed according to parameters originally configured in step 106.

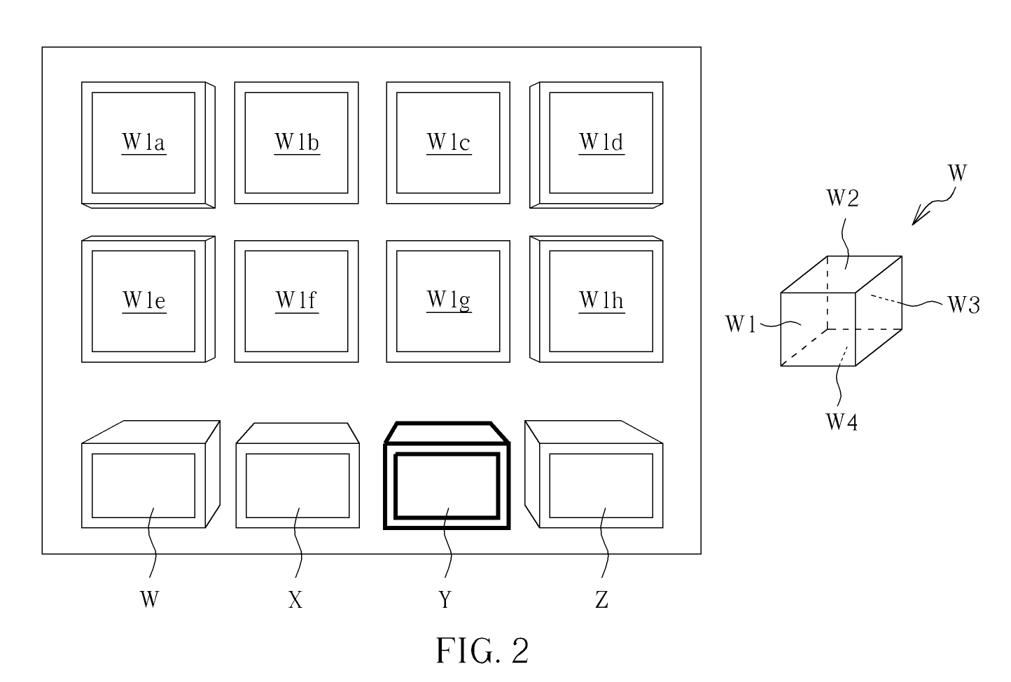

Please refer to FIG. 2. FIG. 2 is a diagram illustrating an embodiment of utilizing method 100 to generate a 3D user interface 20. In the present embodiment, user interface 20 comprises cubes W-Z, and each of the cubes W-Z comprises four surfaces along the vertical direction. For instance, cube W comprises surfaces W1, W2, W3 and W4 along the vertical direction of cube w; cube Y comprises surfaces Y1, Y2, Y3 and Y4 along the vertical direction of cube W and so on. Each of the cubes W-Z represents one major class and the four surfaces along the vertical direction of each cube represent four sub-classes. Each sub-class corresponds to a plurality of options illustrated by slabs; in the present embodiment, each sub-class corresponds to 8 options but is not limited to this. In other words, each of the four surfaces along the vertical direction of each cube corresponds to a plurality of slabs, e.g. surface W1 corresponds to slabs W1a-W1h.

For instance, if user interface 20 is utilized for a digital camera, the major classes represented by cubes W-Z can be set to “Camera”, “Playback”, “Video” and “Customize” respectively. Each major class comprises sub-classes. Taking the major class “Camera” represented by cube W as an example, the corresponding sub-classes represented by surfaces W1-W4 of cube W can be set to “Mode”, “Picture Format”, “Focus” and “Exposure” respectively. Options represented by slabs W1a-W1h correspond to surface W1 (e.g. sub-class “Mode”) can be set to “Manual”, “Auto”, “Aperture Priority”, “Shutter Priority”, “Program Mode”, “Scene Mode”, “Custom Mode 1” and “Custom Mode 2” respectively. This way, all options can be integrated into one user interface 20. User can slide or tap cubes W-Z for desired options, without flipping through different pages or layers of user interface.

Interface 20 is generated according to method 100 illustrated in FIG. 1. Firstly, steps 102-106 of method 100 are executed to initialize image frames (e.g. cubes W-Z and corresponding slabs) of user interface 20. For instance, in step 104, the display mode can be set to cube with corresponding slabs. In step 106, parameters of image frames (e.g. cubes W-Z and the relative slabs) are set, such as setting coordinates of cubes W-Z and the relative slabs, as well as setting movement trace and frame rate for movements of cube sliding and slabs transition etc. The function related to each image frame (e.g. cube, and the corresponding slabs) is also configured.

The user interface 20 is then displayed according to the set parameters. User interface 20 may start with a default display, for instance, surface W1 of cube W is selected and the corresponding slabs W1a-W1h are displayed as default. When a cube is selected, the border of selected cube can be, for instance, illustrated with bold border or in a different color from other cubes. Also, selected surface of a cube confronts the user, e.g. the selected surface is at a plane closest to the user. The cube can be slid to select desired sub-class of options.

If a new input command is received while displaying the user interface 20, for instance, a user slides from surface W1 of cube W to surface W2 of cube W. Parameters are reconfigured such that the movement trace of cube W is configured so as to display a sliding effect in response to the user's sliding action; the coordinates and movement trace of slabs W1a-W1h and W2a-W2h are also reconfigured so as to perform the vertical transition from slabs W1a-W1h to slabs W2a-W2h. The vertical transition from slabs W1a-W1h to slabs W2a-W2h may require several frames to complete, hence the frame rate may be reconfigured according to how fast the user slides the cube W.

Please note that the above embodiment of user interface 20 is merely an exemplary illustration of the present invention, those skilled in the art can certainly make appropriate modifications such as implementing a different number of major classes (e.g. cube) or setting a different number of options (e.g. slabs) corresponding to one sub-class (e.g. a surface of a cube) etc., according to practical demands which also belong to the scope of the present invention.

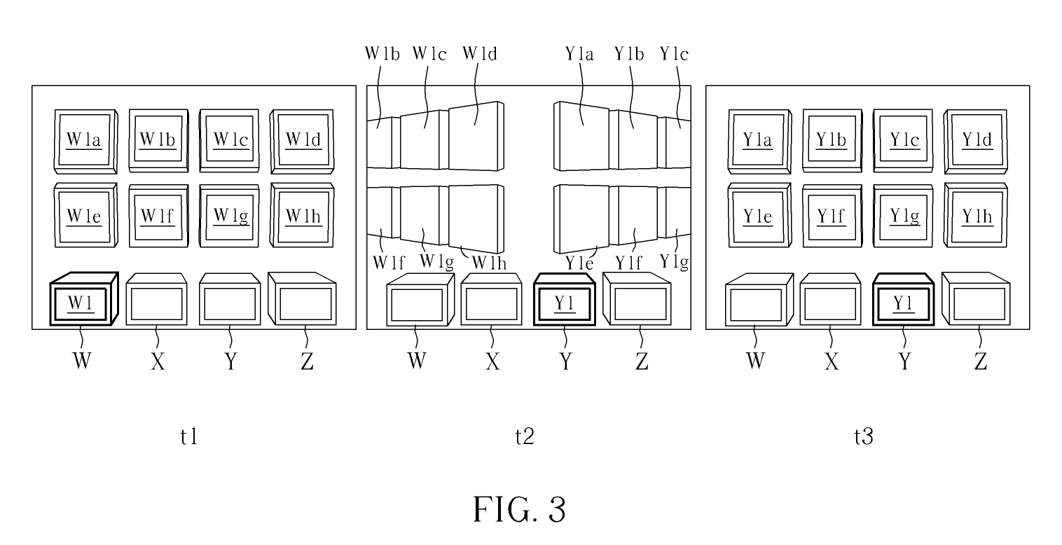

Please refer to FIG. 3. FIG. 3 is a diagram illustrating an embodiment of selecting a different major class of 3D user interface 20 in FIG. 2. When a different surface (i.e. sub-class) is selected, the corresponding slabs (i.e. options) are then displayed. As shown in FIG. 3, surface W1 of cube W is selected originally at time t1 and the corresponding slabs W1a-W1h are displayed. When a different sub-class, for instance, surface Y1 of cube Y is selected at time t2, slabs W1a-W1h are transited to slabs Y1a-Y1h which correspond to surface Y1. The transition completes at time t3 and slabs Y1a-Y1h are displayed. In the present embodiment, the transition of displaying slabs W1a-W1h to slabs Y1a-Y1h is according to a vertical movement trace as shown in FIG. 3.

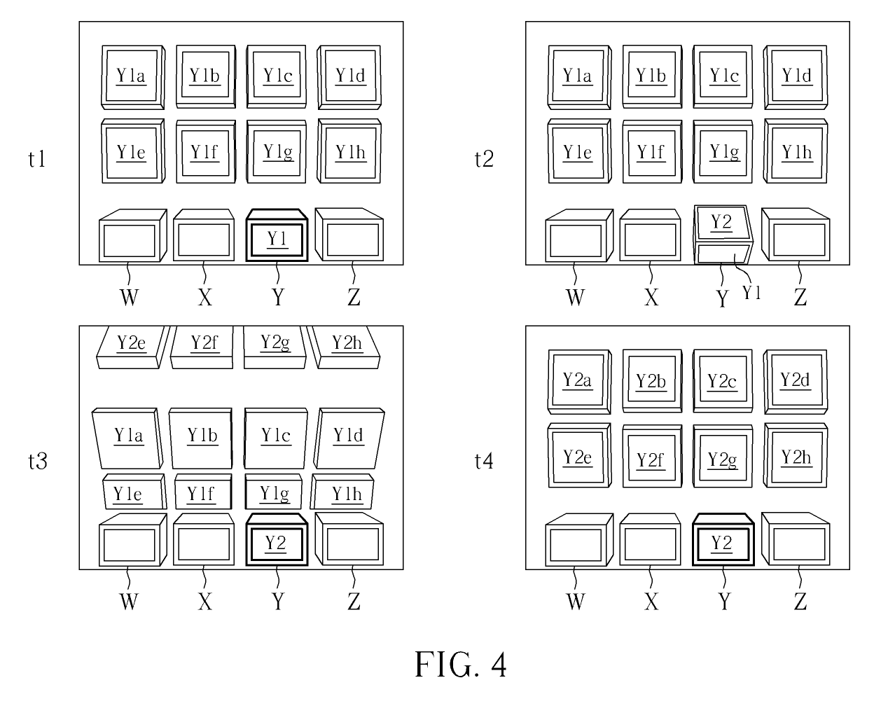

Please refer to FIG. 4. FIG. 4 is a diagram illustrating an embodiment of selecting a different sub-class from the same major class of 3D user interface 20 in FIG. 2. Different sub-classes of a same major class can be selected by, for instance, sliding the same cube in the vertical direction. As shown in FIG. 4, surface Y1 of cube Y is selected originally and the corresponding slabs Y1a-Y1h are displayed at time t1. When a different sub-class of the same major class is selected, for instance, a user slides cube Y to surface Y2 from surface Y1, cube Y is rotated according to the user input to display surface Y2 on a plane closest to the user at t2. Slabs Y1a-Y1h are then transited to slabs Y2a-Y2h which correspond to surface Y2 at time t3. Transition completes at time t4 to show surface Y2 of cube Y is selected and the corresponding slabs Y2a-Y2h are displayed.

In the present embodiment, the transition of slabs corresponding to different surfaces e.g. transiting slabs Y1a-Y1h to slabs Y2a-Y2h, is according to a vertical movement trace as shown in FIG. 4, but is not limited to this. This way, the movement trace for selecting a different sub-class from the same major class (e.g. slabs transit vertically) of 3D user interface 20 is distinguished from selecting a different sub-class from a different major class (e.g. slabs transit horizontally) of 3D user interface 20.

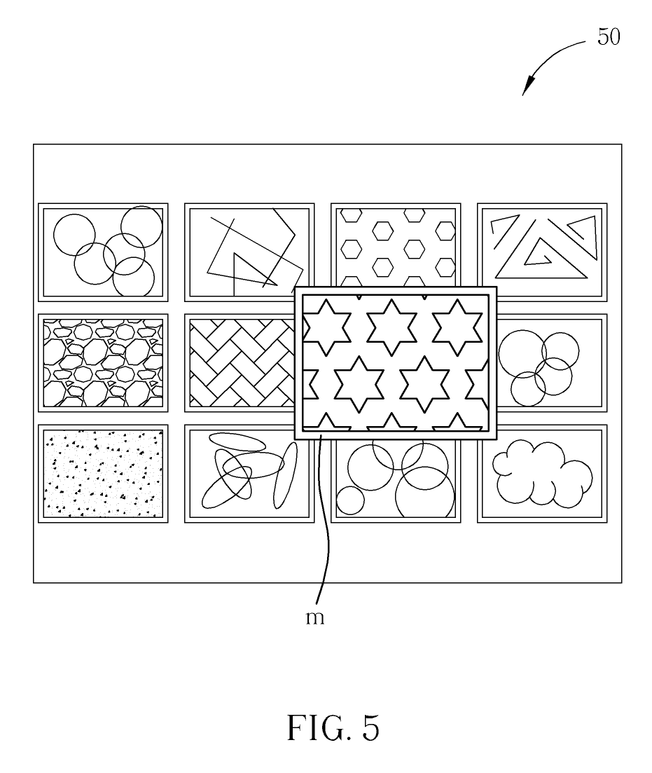

Please refer to FIG. 5. FIG. 5 is a diagram illustrating an embodiment of utilizing method 100 to generate a photo wall 50. As shown in FIG. 5, photo wall 50 can be utilized to display a plurality of images such as photos, or thumbnails of images. In other embodiments, photo wall 50 can also display thumbnails of documents, audio or video files etc. In the present embodiment, display mode is set to photo wall in step 104 of method 100. Parameters such as coordinates, movement trace and frame rate of image frames (e.g. images or thumbnails of images) are also set in step 106 of method 100. The photo wall 50 can be slid to show different images according to user input. For instance, by sliding the photo wall horizontally or vertically, the photo wall performs slides towards left or right, or up or down respectively. The sliding speed of the photo wall 50 corresponds to that of user's sliding operation. The photo wall 50 supports functions such as photo zooming and rotation. For instance, a user can select and zoom-in (e.g. double tap) an image m in the photo wall 50 at time t1; the user may also rotate the zoomed-in picture m.

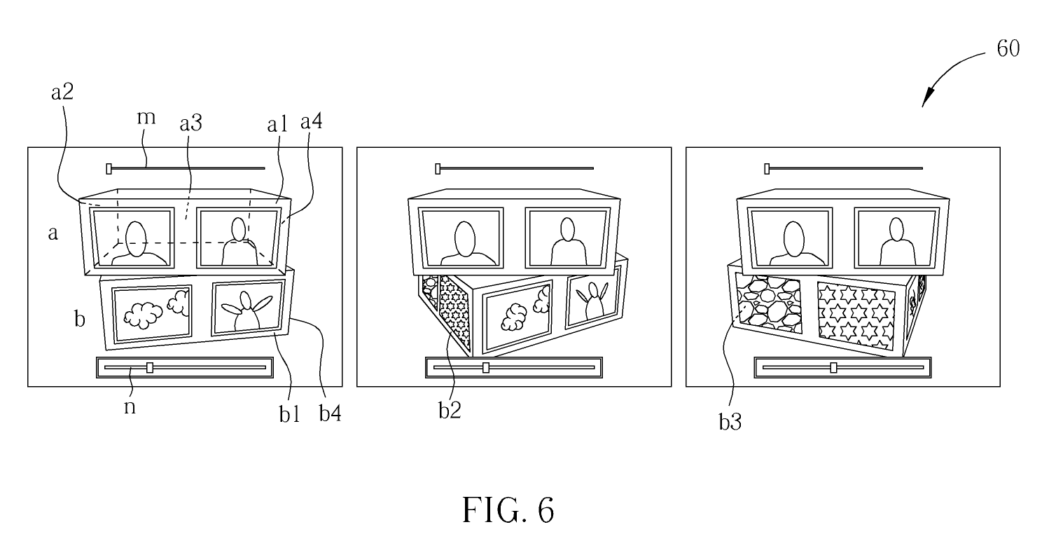

Please refer to FIG. 6. FIG. 6 is a diagram illustrating an embodiment of utilizing method 100 to generate a photo cube 60. In the present embodiment, the display mode is set to photo cube in step 104 of method 100. In photo cube mode, a plurality of cubes is combined/stacked. In the present embodiment, photo cube 60 comprises cubes a and b, but is not limited to two cubes. Parameters such as coordinates, movement trace and frame rate of image frames, e.g. photo cubes 60 are set in step 106 of method 100. Surfaces on the side (e.g. along horizontal direction) of each cube a or b are utilized to present images. In the present embodiment, cubes a and b are stacked on top of each other; images are presented on surfaces a1-a4 of cube a and surfaces b1-b4 on cube b. Bars m and n may be disposed for controlling the sliding movement of cubes a and b. For instance, cube a or b is rotated towards left or right horizontally by a user sliding bar m or n in the corresponding directions. In other embodiment, photo cube 60 may be realized without bars m and n. User can slide the cube a or b directly to control the rotation of the cube a or b respectively.

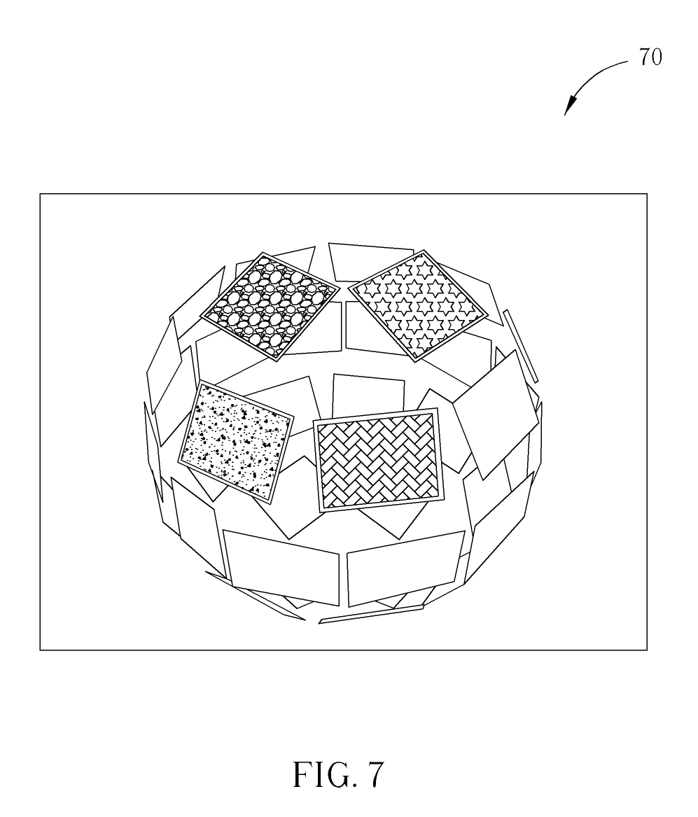

Please refer to FIG. 7. FIG. 7 is a diagram illustrating an embodiment of utilizing method 100 to generate a photo sphere 70. Photo sphere 70 presents a plurality of images according to a sphere shape. In the present embodiment, the display mode is set to photo sphere in step 104 of method 100. Parameters such as coordinates, movement trace and frame rate of image frames, e.g. images presented on photo sphere 70, are set in step 106 of method 100. Setting coordinates of photo sphere 70 may comprise setting location/angle of each image on the photo sphere 70, size of the photo sphere 70, and spacing between each image presented on the photo sphere 70 etc. The movement trace of photo sphere 70 may comprise horizontal, vertical or diagonal rotation according to user input. In addition, rotating speed of photo sphere 70 may also be altered according to user input. Photo sphere 70 can also be zoomed in/out, either by zooming in/out a specific image on the photo sphere 70 or the whole photo sphere 70. A user slides the photo sphere 70 or zooms in/out an image/photo sphere 70 is equivalent to sending input command, so as to reconfigure parameters of the photo sphere 70 to perform corresponding actions.

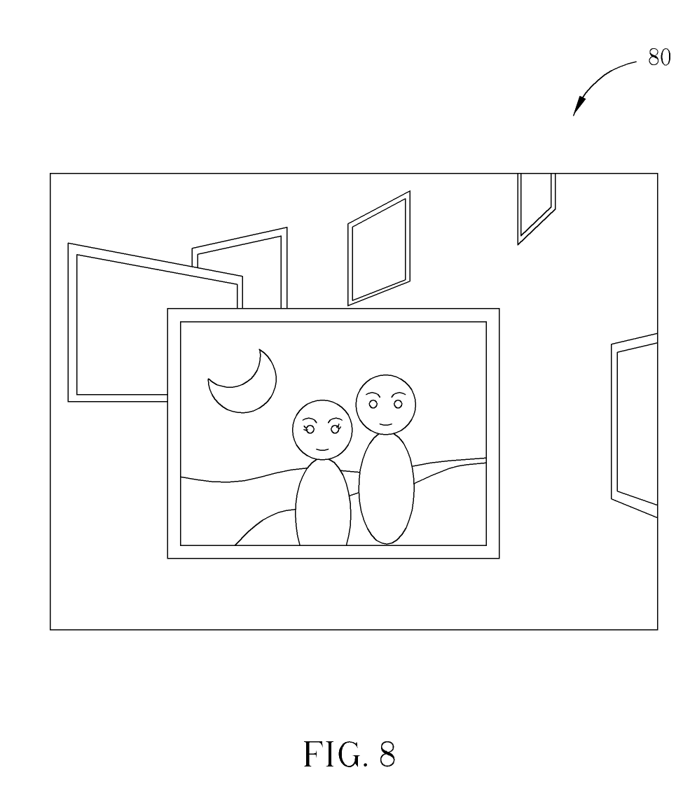

Please refer to FIG. 8. FIG. 8 is a diagram illustrating an embodiment of utilizing method 100 to generate a photo spiral 80. Photo spiral 80 presents a plurality of images according to a spiral shape. Photo spiral 80 can present images in spirals of different directions, e.g. horizontal or vertical spiral. In the present embodiment, the display mode is set to photo spiral in step 104 of method 100. Parameters such as coordinates, movement trace and frame rate of image frames, e.g. images presented on photo spiral 80, are set in step 106 of method 100. Setting coordinates of photo spiral 80 may comprise setting the location/angle of images on the photo spiral 80, the angle of whirls of photo spiral 80 and the spacing between each image presented on the photo spiral 80 etc. The movement trace of photo spiral 80 may comprise setting the helix trajectory for the presented images to be moved along with. Images presented on photo spiral 80 may be moved according to input command. For instance, a user may slide the photo spiral 80 in a down or right direction to present a next image; a user may slide the photo spiral 80 in an up or left direction to present a previous image.

Please note that the above embodiments utilizing method 100 are merely exemplary illustrations of the present invention, those skilled in the art can certainly make appropriate modifications according to practical demands which also belong to the scope of the present invention.

In conclusion, the present invention provides a method for generating three-dimensional image frames. The method of the present invention generates image frames without requiring 3D hardware support. The method of the present invention is especially useful for devices that are usually without 3D hardware, such as handheld devices like digital still cameras, mobile phones and digital photo frames. Also, the method of the present invention does not require assistant peripherals such as 3D display panel or 3D glasses to generate 3D effects. Similarly, the method of the present invention does not require software architecture such as OpenGL/ES or DirectX etc to generate image frames to achieve 3D effects. The existing hardware installed need not to be altered for implementing the method of the present invention. Moreover, the method of the present invention also provided expandability. Different 3D effects other than the embodiments specified above may be implemented without altering the mainframe of method of the present invention. This way, user experience can be greatly enhanced, through the 3D user interface or 3D presentation generated by the method of the present invention.

Those skilled in the art will readily observe that numerous modifications and alterations of the device and method may be made while retaining the teachings of the invention.

What is claimed is:

1. A method for generating image frames, comprising:
setting a 3D display mode of the image frames;
configuring at least one parameter of the image frames;
displaying the image frames according to the 3D display mode and the at least one parameter of the image frames;
when an input command is received while displaying the image frames, determining whether the input command corresponds to the at least one parameter of the image frames; and
if the input command does not correspond to the at least one parameter, reconfiguring the at least one parameter according to the input command.

2. The method of claim 1, wherein configuring the at least one parameter of the image frames comprises:
configuring coordinates of the image frames;
configuring movement traces of the image frames; and
configuring a frame rate of the image frames.

3. The method of claim 1, wherein setting the display mode of the image frames comprises setting the display mode of the image frames to be a photowall, spiral or sphere mode.

4. The method of claim 1, further comprising:
if the input command corresponds to the at least one parameter, displaying the image frames without reconfiguring the at least one parameter of the image frames.

5. The method of claim 1, wherein the input command is generated according to a user input, or system generated.

6. The method of claim 1, further comprising:
decoding the input command, so as to identify content of the input command.

7. The method of claim 1, wherein the image frames are icons for triggering different functions.

8. The method of claim 1, further comprising:
requesting identifications of the image frames.

9. The method of claim 1, further comprising forwarding the image frames to a frame buffer one by one.
